(19) United States
(12) Patent Application Publication
(10) Pub. No.: US 2011/0145110 A1
(43) Pub. Date: Jun. 16, 2011

(54) INDEX INFORMATION MANAGEMENT DEVICE AND METHOD ACCORDING TO CHARGING PERIOD IN SERVICE LEVEL AGREEMENT SYSTEM

(75) Inventors: Eunjin KO, Daejeon (KR); Hyun Chul KANG, Daejeon (KR); Ilgu JUNG, Daejeon (KR); Byung Yun LEE, Daejeon (KR); Byung Sun LEE, Daejeon (KR)

(73) Assignees: Electronics and Telecommunications Research Institute, Daejeon (KR); KT CORPORATION, Seongnam-city (KR)

(21) Appl. No.: 12/965,276

(22) Filed: Dec. 10, 2010

(30) Foreign Application Priority Data
Dec. 11, 2009 (KR) 10-2009-0123305
Apr. 29, 2010 (KR) 10-2010-0040154

(51) Int. Cl. G06Q 10/00; G06Q 30/00

(52) U.S. Cl. 705/30; 705/1.1

(57) ABSTRACT

An index management device of a service level agreement system includes: an external link processor for receiving a customized service request for requesting a different service per subscriber received by a subscriber subscription management system; a quality manager for extracting needed information from output information from the external link processor; an index management interface for checking a characteristic of the output information from the quality manager and an information management method; a table storage unit for storing index information of the service level agreement system; and an index manager for managing the index information stored in the table storage unit according to the customized service request and a request from the index management interface.

### CROSS-REFERENCE TO RELATED APPLICATION

This application claims priority to and the benefit of Korean Patent Applications No. 10-2009-0123305 filed in the Korean Intellectual Property Office on Dec. 11, 2009 and No. 10-2010-0040154 filed therein on Apr. 29, 2010, the entire contents of which are incorporated herein by reference.

### BACKGROUND OF THE INVENTION

(a) Field of the Invention

The present invention relates to an index information management device of a service level agreement system, and an index information management method according to a charging period of the service level agreement system.

(b) Description of the Related Art

A service level agreement (SLA) is an agreement that provides a service corresponding to a previously defined level from a service provider to a service subscriber by an agreement between them. In general, a management system for such a service level agreement provides the same communication QoS to communication service subscribers. However, needs for having each subscriber select a desired index and guaranteeing SLA management that is appropriate for the subscriber as well as providing simple SLA management have been generated.

Accordingly, in order to provide a customized SLA function for differentiating an applicable index for each subscriber and levels, it is required to apply an index change request provided by a subscriber service processing system to the SLA system according to a charge applied period. Also, more precise index information control is needed in order to prevent stoppage of the SLA system in simultaneous consideration of processing the index change request that is input in cooperation with an information transfer task of an index control table on the application reference day.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an information management method for a SLA system to process an index change request by a subscriber that is required with an information transfer task of an index control table according to a charging period without interrupting the system.

An exemplary embodiment of the present invention provides an index management device of a service level agreement system, including: an external link processor for receiving a customized service request for requesting a different service per subscriber received by a subscriber subscription management system; a quality manager for extracting needed information from output information from the external link processor; an index management interface for checking a characteristic of the output information from the quality manager and an information management method; a table storage unit for storing index information of the service level agreement system; and an index manager for managing the index information stored in the table storage unit according to the customized service request and a request from the index management interface.

The table storage unit includes: a future metrics table for storing per-subscriber information to be applicable in the next month, a current metrics table for storing the per-subscriber information applicable to the current month, an old metrics table for storing the per-subscriber information for the previous month, an Scn_slayn_fut table for storing a state of whether the subscriber has selected the customized service request, and an Scn_slayn_old table for storing a state of whether the subscriber selected the customized service request in the past.

The future metrics table includes a customer identifier, a service level agreement index code, an index value, an alarm threshold value, a compensation multiple, a process finish state, and a system time.

The current metrics table includes a customer identifier, an index code, an index value, an alarm threshold value, a compensation multiple, and a system time.

The old metrics table includes a customer identifier, an index code, an index value, an alarm threshold value, a compensation multiple, and a system time.

The Scn_slayn_fut table includes a customer identifier, a customization selection state, a process finish state, and a system time.

The Scn_slayn_old table includes a customer identifier, a customization selection state, and a system time.

Another embodiment of the present invention provides a method for an index information management device of a service level agreement system (SLA) system to manage a service level agreement index, including: receiving subscriber subscription information including a customized service request for requesting a different service for each subscriber from a subscriber subscription management system; determining whether a period has reached a transfer period by searching for charging period information; when it has reached the transfer period, extracting a first customer identifier and a first customized service request state value from an Scn_slayn_fut table for storing a state of whether the subscriber has selected the customized service request; searching a second customer identifier and a second customized service request state value corresponding to the first customer identifier and the first customized service request state value from a subscriber information table; storing the second customer identifier and the second customized service request state value in an Scn_slayn_old table for storing a state of whether the subscriber selected the customized service request in the past; and updating the first customer identifier and the first customized service request state value to the subscriber information table.

The extracting includes targeting the case in which the first customization selecting state value and the second customization selecting state value are different by targeting information with a process finish field value of the Scn_slayn_fut table as positive.

The method further includes: comparing a current metrics table for storing per-subscriber information applicable to the current month and an old metrics table for storing the per-subscriber information; deleting information that is stored not in the current metrics table but in the old metrics table from the old metrics table; transferring information that is stored in the old metrics table and the current metrics table to the old metrics table; and storing information that is stored not in the old metrics table but in the current metrics table in the old metrics table.

The method further includes, when it has not reached the transfer period, searching for charging period information again.

The method further includes: reading a third customer identifier, an index code, an index value, an alarm threshold value, and a compensation multiple of a future metrics table for storing per-subscriber information to be applied in the next month; finding a fourth customer identifier corresponding to the third customer identifier from the current metrics table and deleting the same; and reproducing the third customer identifier, the index code, the index value, the alarm threshold value, and the compensation multiple to the current metrics table.

The reading targets information with a process finish state value of the future metrics table as positive.

Yet another embodiment of the present invention provides a method for an index information management device of a service level agreement (SLA) system to manage a service level agreement index, including: receiving an information reference request from a subscriber having requested a customized service for requesting different services for respective subscribers; when the information reference request is a current charging period information reference, determining whether information on the customized service request is transferred to an Scn_slayn_old table for storing a state of whether the subscriber selected the customized service request in the past; when the information is transferred to the Scn_slayn_old table, searching an Scn_slayn_fut table for storing a state of whether the subscriber has selected the customized service request; and when there is no search result, referring to the customized service request of a subscriber information table.

The method further includes, when the information is not transferred to the Scn_slayn_old table, referring to the customized service request of the subscriber information table.

The method further includes, when the information reference request is not a current charging period information reference, determining whether a period has reached a transfer period, and when the period has reached the transfer period, referring to the customized service request of the subscriber information table.

The method further includes, when the period has not reached the transfer period, referring to the customized service request of the Scn_slayn_old table.

Yet another embodiment of the present invention provides a method for an index information management device of a service level agreement (SLA) system to manage a service level agreement index, including: receiving an information reference request from a subscriber having requested a customized service for requesting different services for respective subscribers; when the information reference request is a current charging period information reference, determining whether contents of the current metrics table for storing information applicable to the current month are transferred to the old metrics table for storing information on the previous month; and when the contents are not transferred, referring to information of the current metrics table.

The method further includes, when the contents are transferred, searching the future metrics table for storing information applicable in the next month, and when there is no search result for the future metrics table, referring to information of the current metrics table.

The method further includes, when the information reference request is not a current charging period information reference, determining whether a subscriber information table is updated with information of an Scn_slayn_fut table for storing a state of whether the subscriber has selected the customized service request; when it is updated, referring to information of the current metrics table; and when there is no reference result on information of the current metrics table, referring to the old metrics table.

### BRIEF DESCRIPTION OF THE DRAWINGS

FIG. 1 shows a block diagram of a service level agreement (SLA) management system according to an exemplary embodiment of the present invention.

FIG. 2 shows index information of an SLA system according to an exemplary embodiment of the present invention.

FIG. 3 shows a flowchart of an index information management method of an SLA system according to an exemplary embodiment of the present invention.

FIG. 4 shows a flowchart of an index information management method of an SLA system according to another exemplary embodiment of the present invention.

FIG. 5 shows a flowchart of an index information management method of an SLA system according to another exemplary embodiment of the present invention.

FIG. 6 shows a flowchart of an index information management method of a SLA system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

An index information management device of a service level agreement system and an index information management method of the service level agreement system according to an exemplary embodiment of the present invention will now be described in detail with reference to accompanying drawings.

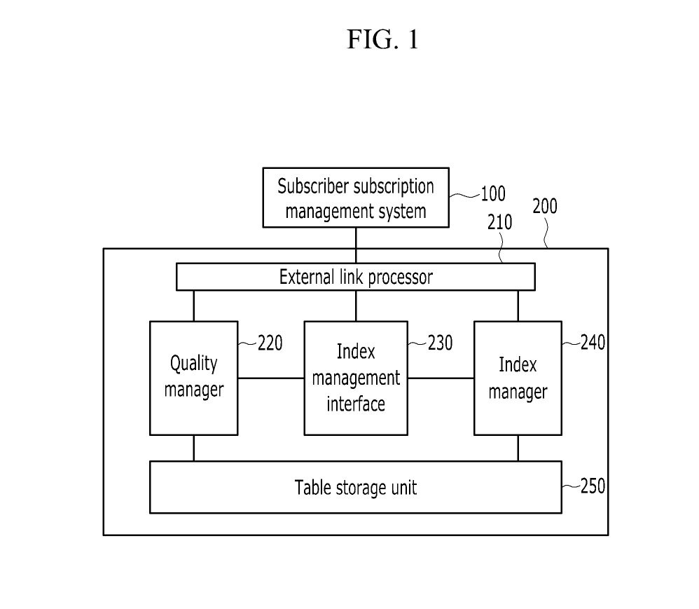

FIG. 1 shows a block diagram of a service level agreement (SLA) management system according to an exemplary embodiment of the present invention.

Referring to FIG. 1, the service level agreement (SLA) management system includes a subscriber subscription management system 100 and an index information management system 200.

The subscriber subscription management system 100 processes a request about usage of a communication service provided by a subscriber. Here, the request about usage of a communication service includes subscription, change, and cancelation of the communication service.

The subscriber subscription management system 100 transmits information on the subscriber's SLA management request state and subscription, change, and cancellation for an SLA management index value to the index information management system 200.

The index information management system 200 performs different SLA management by managing index information for each subscriber according to the subscriber's subscription, and includes an external link processor 210, a quality manager 220, an index management interface 230, an index manager 240, and a table storage unit 250.

The external link processor 210 receives the subscriber's subscription contents from the subscriber subscription management system 100 to process the same, and transmits the processed contents to the quality manager 220.

The quality manager 220 extracts essential information from among the processed contents provided by the external link processor 210 and transmits extracted information to the index management interface 230.

The index management interface 230 checks a characteristic of information provided by the quality manager 220 and an information management method, and requests information management from the index manager 240.

Upon being requested by the index management interface 230 about information management, the index manager 240 stores, changes, or deletes information stored in the table storage unit 250. Also, the index manager 240 transfers information to the table storage unit 250 according to the charging period.

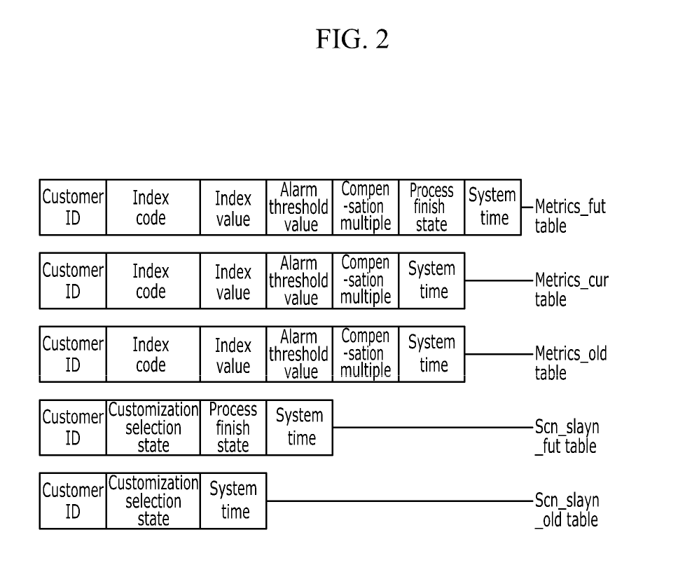

The table storage unit 250 stores information used for index management of the SLA system, which will now be described in detail with reference to FIG. 2.

FIG. 2 shows index information of an SLA system according to an exemplary embodiment of the present invention.

Referring to FIG. 2, index information of the SLA system includes a future metrics (Metrics_fut) table, a current metrics (Metrics_cur) table, an old metrics (Metrics_old) table, an Scn_slayn_fut table, and an Scn_slayn_old table.

The Metrics_fut table includes per-subscriber customer identifier, an SLA index code, an index value, an alarm threshold value, a compensation multiple, a process finish state, and a system time to be applied in the next month.

The current metrics table includes a customer identifier, an index code, an index value, an alarm threshold value, a compensation multiple, and a system time applicable to the current month.

The old metrics table stores index information on the fact that an accumulative index is determined after the month to be determined has passed, and it includes a customer identifier, an index code, an index value, an alarm threshold value, a compensation multiple, and a system time.

The Scn_slayn_fut table stores whether the corresponding subscriber has selected differential SLA management according to the customer, and it includes a customer identifier, a customization selection state, a process finish state, and a system time. Here, the customization selection state indicates whether the subscriber has requested an SLA service that is differentially managed by the customer request.

The Scn_slayn_old table stores information for checking whether the corresponding customer has selected differential SLA management when the accumulative index is determined, and it includes a customer identifier, a customization selection state, and a system time.

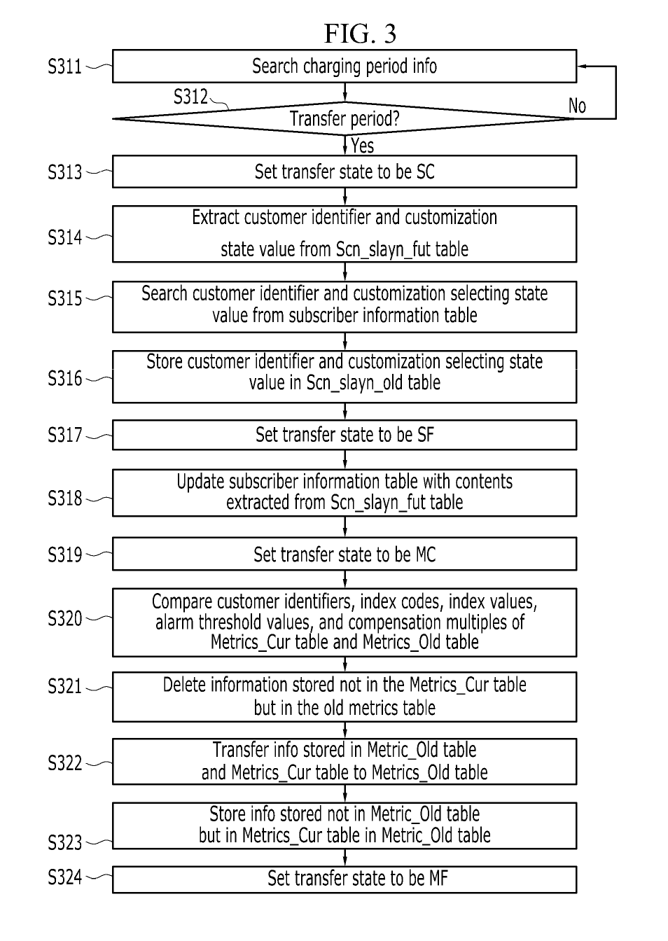

An index information management method of an SLA system according to an exemplary embodiment of the present invention will now be described with reference to FIG. 3 to FIG. 6.

FIG. 3 shows a flowchart of an index information management method of an SLA system according to an exemplary embodiment of the present invention.

Referring to FIG. 3, the index information management device 200 receives subscriber's subscription information from the subscriber subscription management system 100, and searches for charging period information in order to transfer the subscriber's differential SLA management information and per-subscriber index information according to the charging period (S311).

The index information management device 200 determines whether a transfer period has come (S312).

When the transfer period has not yet come, it returns to the searching of transfer period information of S311. When the transfer period has not yet come, the transfer state is set to be “SC” (S313).

A customer identifier and a customization state value are extracted from the Scn_slayn_fut table (S314). In this instance, the customer identifier and the customization state value extracted from the Scn_slayn_fut table target information with the value of a process finish state field of the Scn_slayn_fut table as “positive (Y)” and target the case in which the customization selecting state value of the Scn_slayn_fut table is different from the customization selecting state value of the subscriber information table.

A customer identifier and a customization selecting state value are searched from subscriber information table (S315). In this instance, the searched customer identifier and the customization selecting state value target the same customer identifier as the customer identifier of the information extracted from the Scn_slayn_fut table and the customization selecting state value of the corresponding customer identifier.

The searched customer identifier and the customization selecting state value are stored in the Scn_slayn_old table (S316). The transfer state value is set to be “SF” since the customization SLA selection information is transferred to the Scn_slayn_old table (S317).

The customer identifier information of the information extracted from the Scn_slayn_fut table and the customization selecting state value are updated to the subscriber information table (S318). Accordingly, the customization SLA selection information transfer is finished and the transfer state value is set to be “MC” (S319).

Customer identifiers, index codes, index values, alarm threshold values, and compensation multiples of the current metrics table and the Metrics_Old table are compared for the accumulative index for summing and processing the values during the charging period so as to transfer metrics information (S320).

The information that is stored not in the current metrics table but in the old metrics table is deleted from the old metrics table (S321).

Further, the information that is stored both in the old metrics table and the current metrics table is transferred to the old metrics table (S322).

Also, the information that is stored not in the old metrics table but in the current metrics table is stored in the old metrics table (S323).

The transfer state value is set to be “MF” (S324).

Then, the task for applying information stored in the current metrics table to the Metrics_Old table according to the charging period is finished.

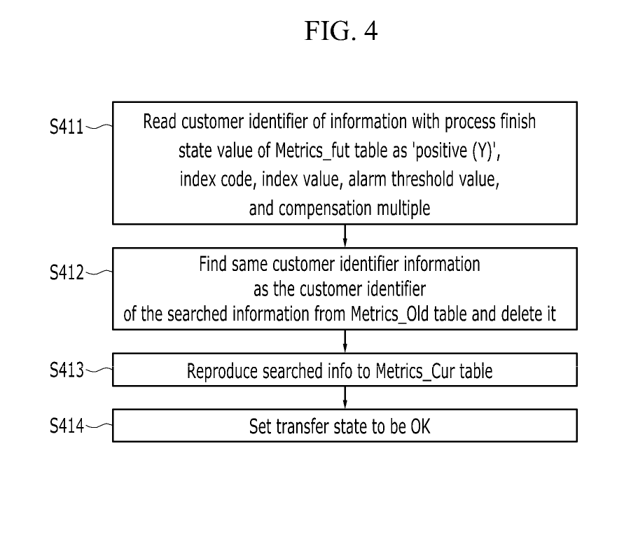

FIG. 4 shows a flowchart of an index information management method of an SLA system according to another exemplary embodiment of the present invention.

Referring to FIG. 4, a customer identifier of information with a process finish state value of the Metrics_fut table as “positive (Y)”, an index code, an index value, an alarm threshold value, and a compensation multiple are read (S411).

The same customer identifier information as the customer identifier of the searched information is found and deleted from the current metrics table (S412).

The searched information is reproduced into the current metrics table (S413) to thus finish the task of reflecting the searched information to the current metrics table according to the charging period.

The transfer state value is set to be “OK” (S414).

The process of FIG. 4 can be performed after the process of FIG. 3.

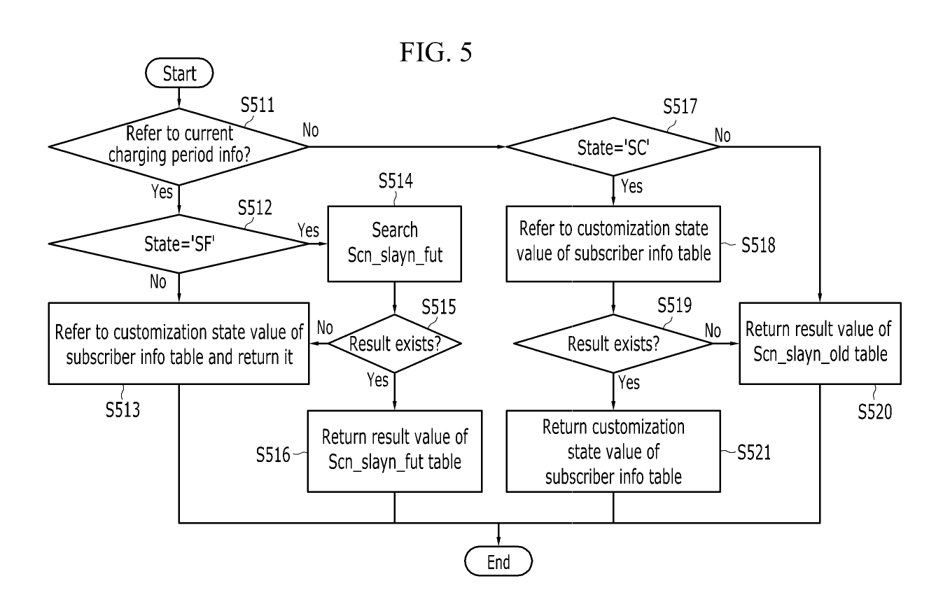

FIG. 5 shows a flowchart of an index information management method of an SLA system according to another exemplary embodiment of the present invention, showing a flowchart of the case of referring to customized SLA selection information for each customer without interrupting management of the customization SLA system in detail.

A customized SLA selection information reference request for a specific customer is received to determine whether it is a current charging period information reference (S511).

When it is a current charging period information reference, it is determined whether the transfer state value is “SF” (S512).

When the transfer state value is not “SF,” the customization state value of the subscriber information table is referred to and is then returned (S513).

When it is found that the transfer state value is “SF,” the Scn_slayn_fut table is searched (S514).

It is determined whether a search result exists (S515). When it is determined that there is a search, the Scn_slayn_fut table result value is returned (S516). When it is determined that there is no search result, a customization state value of the subscriber information table is referred to and is returned (S513).

When it is not a current charging period information reference according to the determination result of S511, it is determined whether the transfer state value is “SC” (S517).

When the transfer state value is “SC,” the customization selecting state value of the subscriber information table is referred to (S518).

It is determined whether a search result exists (S519). When it is determined that a search result exists, the result value of the Scn_slayn_old table is returned (S520). When it is determined that no search result exists, the customization state value of the subscriber information table is referred to and is returned (S521).

When the transfer state value is not “SC” according to the determination result of S517, the customization state value of the Scn_slayn_old table is referred to and is returned (S520).

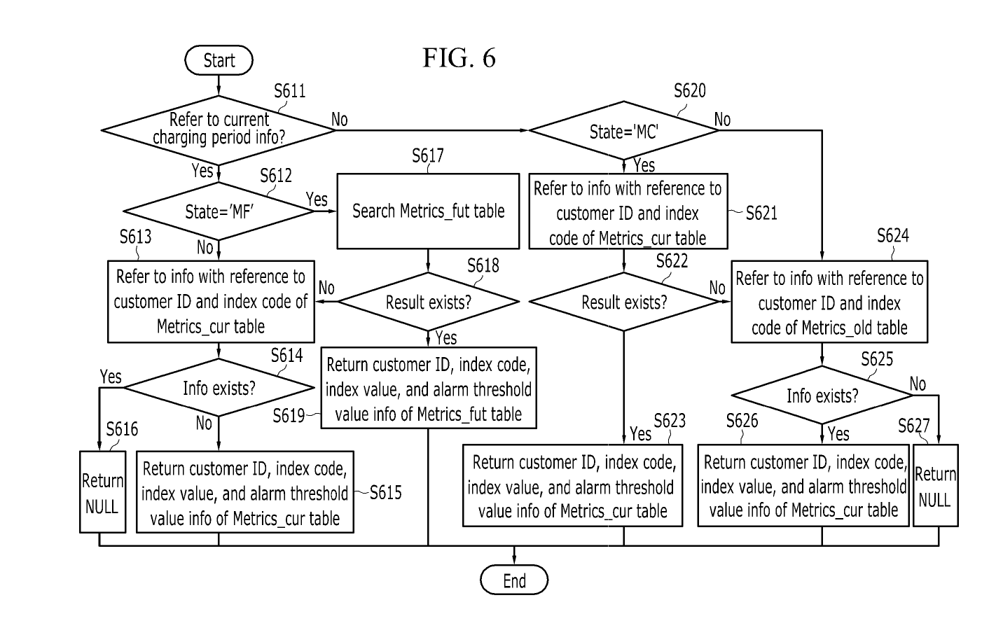

FIG. 6 shows a flowchart of an index information management method of an SLA system according to another exemplary embodiment of the present invention, showing a flowchart of the case of referring to index information selected by a customization selection subscriber without interrupting management of the customization SLA system in detail.

Referring to FIG. 6, when selection index reference of a specific customer having selected customization is requested, it is determined whether a current charging period information reference is requested (S611).

When the current charging period information reference is requested, it is determined whether the transfer state value is “MF” (S612).

When the transfer state value is not “MF,” information is referred to with reference to the customer identifier and index code in the current metrics table (S613). It is determined whether a reference result exists (S614). When there is a reference result, the customer identifier, the index code, the index value, and the alarm threshold value information are returned from the current metrics table (S615). When there is no reference result, a null is returned (S616).

When the transfer state value is “MF” according to the determination result of S612, the Metrics_Fut table is searched (S617). It is determined whether there is a search result (S618). When there is a search result, the customer identifier, the index code, the index value, the alarm threshold value, and the compensation multiple information of the Metrics_Fut table are returned (S619). When there is no search result, information is referred to from the current metrics table with reference to the customer identifier and the index code (S613).

When it is not a current charging period information reference according to the determination result of S611, it is determined whether the transfer state value is MC (S620). When the transfer state value is MC, the customer identifier and the index code information of the current metrics table are referred to (S621). It is determined whether there is a reference result (S622). When there is a reference result, the customer identifier, the index code, the index value, the alarm threshold value, and the compensation multiple information of the current metrics table are returned (S623). When there is no reference result, the customer identifier and the index code information of the old metrics table are referred to (S624). It is determined whether there is a reference result (S625). When there is a reference result, the customer identifier, the index code, the index value, the alarm threshold value, and the compensation multiple information of the old metrics table are returned (S626). When there is no reference result, a null is returned (S627).

According to an embodiment of the present invention, an information management method for an SLA system to process an index change request by a subscriber that is required with an information transfer task of an index control table according to a charging period without interrupting the system is provided to efficiently apply various indexes for respective subscribers.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An index information management device of a service level agreement (SLA) system, comprising:
an external link processor for receiving a customized service request for requesting a different service per subscriber received by a subscriber subscription management system;
a quality manager for extracting needed information from output information from the external link processor;
an index management interface for checking a characteristic of the output information from the quality manager and an information management method;
a table storage unit for storing index information of the service level agreement system; and
an index manager for managing the index information stored in the table storage unit according to the customized service request and a request from the index management interface.

2. The index information management device of claim 1, wherein
the table storage unit comprises:
a future metrics table for storing per-subscriber information to be applicable in the next month, a current metrics table for storing the per-subscriber information applicable to the current month, an old metrics table for storing the per-subscriber information for the previous month, an Scn_slayn_fut table for storing a state of whether the subscriber has selected the customized service request, and an Scn_slayn_old table for storing a state of whether the subscriber selected the customized service request in the past.

3. The index information management device of claim 2, wherein
the future metrics table comprises a customer identifier, a service level agreement index code, an index value, an alarm threshold value, a compensation multiple, a process finish state, and a system time.

4. The index information management device of claim 2, wherein
the current metrics table comprises a customer identifier, an index code, an index value, an alarm threshold value, a compensation multiple, and a system time.

5. The index information management device of claim 2, wherein
the old metrics table comprises a customer identifier, an index code, an index value, an alarm threshold value, a compensation multiple, and a system time.

6. The index information management device of claim 2, wherein
the Scn_slayn_fut table comprises a customer identifier, a customization selection state, a process finish state, and a system time.

7. The index information management device of claim 2, wherein
the Scn_slayn_old table comprises a customer identifier, a customization selection state, and a system time.

8. A method for an index information management device of a service level agreement system (SLA) system to manage a service level agreement index, comprising:
receiving subscriber subscription information comprising a customized service request for requesting a different service for each subscriber from a subscriber subscription management system;
determining whether a period has reached a transfer period by searching for charging period information;
when it has reached the transfer period, extracting a first customer identifier and a first customized service request state value from an Scn_slayn_fut table for storing a state of whether the subscriber has selected the customized service request;
searching a second customer identifier and a second customized service request state value corresponding to the first customer identifier and the first customized service request state value from a subscriber information table;
storing the second customer identifier and the second customized service request state value in an Scn_slayn_old table for storing a state of whether the subscriber selected the customized service request in the past; and
updating the first customer identifier and the first customized service request state value to the subscriber information table.

9. The method of claim 8, wherein
the extracting comprises
targeting the case in which the first customization selecting state value and the second customization selecting state value are different by targeting information with a process finish field value of the Scn_slayn_fut table as positive.

10. The method of claim 8, further comprising:
comparing a current metrics table for storing per-subscriber information applicable to the current month and an old metrics table for storing the per-subscriber information;
deleting information that is stored not in the current metrics table but in the old metrics table from the old metrics table;
transferring information that is stored in the old metrics table and the current metrics table to the old metrics table; and
storing information that is stored not in the old metrics table but in the current metrics table in the old metrics table.

11. The method of claim 8, further comprising,
when it has not reached the transfer period, searching for charging period information again.

12. The method of claim 8, further comprising:
reading a third customer identifier, an index code, an index value, an alarm threshold value, and a compensation multiple of a future metrics table for storing per-subscriber information to be applied in the next month;
finding a fourth customer identifier corresponding to the third customer identifier from the current metrics table and deleting the same; and
reproducing the third customer identifier, the index code, the index value, the alarm threshold value, and the compensation multiple to the current metrics table.

13. The method of claim 12, wherein
the reading targets information with a process finish state value of the future metrics table as positive.

14. A method for an index information management device of a service level agreement (SLA) system to manage a service level agreement index, comprising:
receiving an information reference request from a subscriber having requested a customized service for requesting different services for respective subscribers;
when the information reference request is a current charging period information reference, determining whether information on the customized service request is transferred to an Scn_slayn_old table for storing a state of whether the subscriber selected the customized service request in the past;
when the information is transferred to the Scn_slayn_old table, searching an Scn_slayn_fut table for storing a state of whether the subscriber has selected the customized service request; and
when there is no search result, referring to the customized service request of a subscriber information table.

15. The method of claim 14, further comprising
when the information is not transferred to the Scn_slayn_old table, referring to the customized service request of the subscriber information table.

16. The method of claim 14, further including,
when the information reference request is not a current charging period information reference, determining whether a period has reached a transfer period, and
when the period has reached the transfer period, referring to the customized service request of the subscriber information table.

17. The method of claim 16, further including,
when the period has not reached the transfer period, referring to the customized service request of the Scn_slayn_old table.

18. A method for an index information management device of a service level agreement (SLA) system to manage a service level agreement index, comprising:
receiving an information reference request from a subscriber having requested a customized service for requesting different services for respective subscribers;
when the information reference request is a current charging period information reference, determining whether contents of the current metrics table for storing information applicable to the current month are transferred to the old metrics table for storing information on the previous month; and
when the contents are not transferred, referring to information of the current metrics table.

19. The method of claim 18, further comprising:
when the contents are transferred, searching the future metrics table for storing information applicable in the next month; and
when there is no search result for the future metrics table, referring to information of the current metrics table.

20. The method of claim 19, further comprising:
when the information reference request is not a current charging period information reference, determining whether a subscriber information table is updated with information of an Scn_slayn_fut table for storing a state of whether the subscriber has selected the customized service request;
when it is updated, referring to information of the current metrics table; and
when there is no reference result on information of the current metrics table, referring to the old metrics table.
